(19) United States
(12) Patent Application Publication
(10) Pub. No.: US 2012/0067362 A1
(43) Pub. Date: Mar. 22, 2012

(54) Smokeless Oral Products

(76) Inventor: Michele Mola, London (GB)

(21) Appl. No.: 13/231,299

(22) Filed: Sep. 13, 2011

(30) Foreign Application Priority Data
Sep. 13, 2010 (GB) 1015216.3

(51) Int. Cl. A24B 13/00; B32B 37/06

(52) U.S. Cl. 131/359; 131/352; 156/70

(57) ABSTRACT

Smokeless oral products are disclosed. In some embodiments, a smokeless oral tobacco product is provided comprising a permeable pouch and smokeless tobacco. The permeable pouch comprises a woven polylactide material. This material may offer the advantages of being sustainable and biodegradable, offering improved control of manufacture and pore size, having antibacterial properties, and/or being resistant to discoloration.

### CLAIM FOR PRIORITY

This application claims priority under 35 U.S.C. §119 to British Application Serial No. GB 1015216.3, filed Sep. 13, 2010. The entire contents of the aforementioned application is herein expressly incorporated by reference.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present innovations are directed generally to smokeless products, and more particularly, to SMOKELESS ORAL PRODUCTS.

### BACKGROUND

Smokeless oral products may comprise smokeless materials, such as smokeless tobacco, that are designed to be placed in the oral cavity of a user for a limited period of time. In use, substances from the smokeless material are adsorbed into the user's bloodstream via the mucosal membranes.

### BRIEF DESCRIPTION OF THE DRAWINGS

The accompanying drawings illustrate various non-limiting, example, innovative aspects in accordance with the present descriptions:

FIG. 1 shows a diagram illustrating a method of producing a smokeless oral product comprising the use of a heat-weld technique according to some embodiments; and

FIG. 2 depicts a smokeless oral product embodiment comprising a woven material which is ultrasonically sealed.

### DETAILED DESCRIPTION

The present invention is directed towards a smokeless oral product comprising a permeable pouch. The pouch is intended to contain smokeless material, such as smokeless tobacco, one or more tobacco substitute materials, and/or the like. The smokeless oral product may be used by being placed in the mouth of the user, for example in the side of the mouth between the cheek and gums. In use, flavors and other substances from the smokeless material may diffuse out of the pouch and into the mouth of the user.

Pouches for use with smokeless oral products may be formed from viscose, a regenerated cellulose material. A raw material used in production of viscose is purified cellulose obtained from specially processed wood pulp. Some embodiments of the invention provide for a pouch material produced from a readily regenerated renewable source or sources, such as, by way of non-limiting example, corn starch, tapioca products, sugarcanes, other annual crops, and/or the like. The use of such materials may avoid pollution caused by production of viscose (e.g., pollution due to the effects of carbon disulfide and other by-products).

In some embodiments, pouch material(s) resist staining and discoloration otherwise caused by moisture present in smokeless materials. In some embodiments, pouch material(s) may have antibacterial properties.

Some pouch materials, like fiber web materials, may have mechanical properties that are directionally specific, in other words, the material is strong when stressed in one direction but weaker when stressed in another. In some embodiments of the invention, mechanical properties of pouch materials are not or are not substantially directionally specific. Some embodiments may provide a material having equivalent mechanical properties in all directions. In some implementations, such a material or materials provide increased control and flexibility in the manufacturing process.

According to a first aspect of some embodiments of the present invention, a smokeless oral product is provided. The smokeless oral product comprises a permeable pouch comprising a woven material, and the pouch contains smokeless material. In some implementations, the smokeless material may comprise a smokeless tobacco material, such as Swedish-style snus.

Depending on the embodiment, the permeable pouch may comprise woven material, non-woven material, and/or a composite material including both woven and non-woven material. The material(s) may comprise polylactide (“PLA”) material, polyolefin (“PO”) material, and/or the like.

According to a second aspect of some embodiments of the present invention, methods of producing a smokeless oral product are provided. In one implementation, the method comprises providing a permeable pouch comprising a woven material and the pouch contains smokeless material, such as smokeless tobacco material. Methods may comprise sealing the material using heat-melt or ultrasonic weld techniques.

The pouch may generally be of a size that is small enough to be comfortably accommodated in the mouth of the user; and be large enough to retain a suitable quantity of smokeless material.

The shape of the pouch may be determined by functional considerations. For example, the pouch may be in a shape that is comfortable for a user.

According to some embodiments, the pouch comprises only front and back surfaces. The two surfaces may comprise separate pieces of material, or alternatively, the two surfaces may be formed from a single sheet of material. In some embodiments, a single section of material that is folded to form the front and back surfaces is used to form the pouch as this reduces the number of seams required. In some embodiments, the material is produced in a single tubular form, and this obviously further reduces the number of seams required and is therefore preferred.

The front and back surfaces may be the same or different sizes and shapes. The two annealed surfaces may be any shape, including regular shapes such as square, oval, triangular etc, or irregular shapes, having straight or curved edges. In some embodiments, however, the surfaces are the same shape and size and are rectangular, or circular.

In alternative embodiments, the pouch may be in the form of a polyhedron, by way of non-limiting example, a tetrahedron or hexahedron (box-form), or a cylinder.

One or all of the surfaces of the pouch may be porous and may comprise woven material. In addition, a single surface may comprise regions of porous and non-porous material, any of which may comprise woven material.

In embodiments in which the pouch is generally rectangular in shape, the pouch may be between 20 mm and 50 mm in length. For example, the pouch may be between 25 mm and 30 mm, between 30 mm and 35 mm, or between 35 mm and 45 mm in length. In some embodiments, preferred lengths for the pouch are 28 mm, 33 mm, and 42 mm. The pouch may be between 10 mm and 20 mm in width, and is preferably between 11 mm and 14 mm, or between 16 mm and 19 mm in width. In some embodiments, preferred widths for the pouch are 12 mm and 18 mm.

The pouch may be configured to have a flexible shape that is capable of being manipulated by the user to provide an optimal arrangement for comfortable use.

The pouch may be configured so that it is capable of providing for the passage of saliva and other substances, such as tobacco constituents, into and out of the pouch. For example, in some embodiments, the pouch is composed entirely of a permeable material which may comprise a woven material. In this case, diffusion may occur across substantially the entire surface of the pouch.

In other embodiments, a proportion of the material comprising the pouch is impermeable to the passage of saliva or other substances, and according to these embodiments, the pouch may be provided with at least one porous surface, which may comprise a woven material. For example, in the case of a polyhedral or cylindrical pouch, one or more of the surfaces of the pouch may be formed from a permeable material which may comprise polylactide or polyolefin material.

In alternative embodiments, one or more non-porous surfaces or regions of the pouch may comprise PLA material.

### Manufacture of the Pouch

The pouch may be sealed to prevent the undesirable release of fragments of the smokeless material into the user's mouth. According to some embodiments, the pouch may be produced by cutting a sheet of suitable permeable material, which may comprise PLA material, into a desired size.

The cut sheet is folded and the side edges are bonded by a suitable method, such as a heat melt-welding method, high frequency welding method, or ultrasonic welding method, to form the pouch. The top edge may be maintained in an unbonded state, to provide access for inserting the smokeless material into the pouch. After the smokeless material is inserted into the pouch the final seam may be sealed by a suitable method such as one of the above-mentioned welding methods. In some embodiments, the sheets are bonded using ultrasonic welding.

A binder may be used to facilitate bonding of the material. In some implementations, the binder may be any suitable adhesive material. For example, thermoplastic binders based on polyacrylates can be used as suitable polymer binders. Alternatively, cross-linkable systems based on vinyl acetate copolymers can be used.

The binder may, in some implementations, comprise a biodegradable material so that the pouch is able to degrade in a natural environment after removal from the mouth of the user and subsequent disposal. If the binder is biodegradable then this may promote disintegration of the smokeless oral product and thus enhance biodegradation.

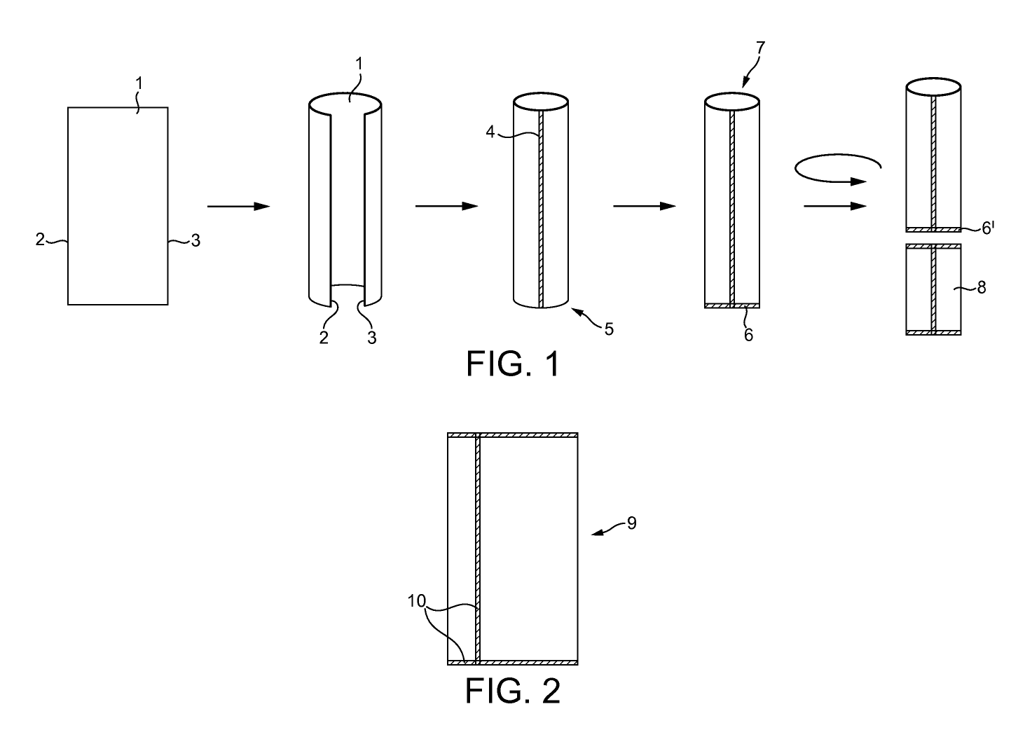

FIG. 1 shows a method of forming a smokeless oral product comprising a heat-melt welding method. In the embodiment shown, a sheet 1 comprising a mixture of woven and non-woven PO material is folded and the opposite edges 2 and 3 are sealed by heat-melt welding to form a tube, having a longitudinal seam 4. The bottom 5 of the tube is then sealed by heat-melt welding to form a lateral seam 6. Smokeless material is then inserted into the tube at the open top end 7. In a final step, which is sequentially repeated to produce multiple smokeless oral products, the tube is heat-melt welded and cut to yield a smokeless oral product 8 and a tube with a bottom seam 6′.

In alternative embodiments, the material may be formed in configuration such that a longitudinal seam is not necessary, such as a tubular configuration or the like.

FIG. 2 shows a pouch formed by a method comprising ultrasonic welding. The method used to form the pouch is analogous to that shown in FIG. 1. The pouch 9 is composed of a woven PLA material. As shown in FIG. 2, the seams 10 of the pouch are much smaller and more discrete than those of the heat-melt welded pouch shown in FIG. 1. Indeed, ultrasonic welding methods may be used to generate seams that are not only smaller, but are more precise, and therefore tidier and more visually appealing. They may also be more comfortable in the mouth of the user. Smaller seams have the further advantage that the amount of woven material required is reduced.

### Pore Size

The pore size of the material comprising the pouch may be selected on the basis of the smokeless material to be used. For example, it is preferable that the pore size of the material is sufficiently small that the amount of any particulate matter that is able to escape the pouch is minimized. On the other hand, the pore size should be large enough to permit free diffusion of water soluble substances across the walls of the pouch.

The chemical nature of the smokeless material may also influence the choice of pore size. For example, if the material in the pouch is relatively hydrophobic, and a very small pore size is used, then the passage of water may be hindered and larger pores may be required.

The ability to regulate the pore size of the material is therefore important. In addition, it may be advantageous to provide a material in which the pores are of a substantially uniform size.

Relative to conventional pouch materials of equivalent mechanical strength, such as fiber web materials, woven materials can have increased porosity. Therefore, the use of woven materials in smokeless oral products can allow enhanced migration of substances from the smokeless material into the mouth. This may be associated with a number of advantages, such as the user being able to obtain a greater concentration of substances from the smokeless material for a particular amount of smokeless material.

According to some embodiments, the porosity, which is the surface area covered by the pores as a proportion of the total surface area, is greater than 5%, in some implementations preferably greater than 7%, 10%, 12%, and most preferably is greater than 15%. In some embodiments, the porosity of the material may be less than 45%, and in some implementations the porosity of the material is preferably less than 35%, 32%, 30%, and most preferably the porosity is less than 25%.

### Pouch Material

The pouch for use in the smokeless oral product may be formed from material comprising woven fibers. The fibers may comprise a polylactide polymer, a polyolefin polymer, and/or the like.

In some implementations, the PLA polymer may be prepared by polymerizing lactic acid or lactide. In some embodiments, the PLA polymer may be a homopolymer or a copolymer of the D and L optical isomers. In some implementations, the polymer may be a mixture of homopolymers and/or copolymers.

Polyolefin describes any of a class of synthetic resins prepared by the polymerization of olefins, which are hydrocarbons containing a carbon double-bond, such as (but not limited to) ethylene, propylene, butenes, isoprenes, and pentenes, and copolymers and modifications thereof.

In some embodiments, a single polyolefin may be used, or alternatively, the material may comprise a combination of different polyolefins.

The fibers comprising the PLA or PO material may be in the form of multifilaments, monofilaments or staple fibers. The staple fibers may be employed in the form of spun yarns, or in the form of composite yarns comprising the staple fibers and the filaments.

The cross-sectional profile of the fibers and filaments may vary widely; however, in some implementations, a circular cross-sectional profile may be preferred.

Several techniques may be employed to make the fibers used for production of the pouch material such as melt spinning or dry spinning.

In order to provide the desired flexibility, permeability, and comfort for the user, the thickness of the fibers may be in the range of between 1 and 100 dtex, and optionally between 5 and 50 dtex.

### Woven Material

The fibers may be formed into a woven material. The term ‘woven’ is intended to mean any method of weaving, knitting, or otherwise interlacing fibers or yarns in a regular, repeating arrangement, to form a fabric material.

It may be undesirable for the fibers to be too thin. For example, if the fibers are less than 1 dtex, then slippage of the yarns may occur during production of the woven material. Increasing the yarn density, however reduces the weaving efficiency. In addition, due to the small pore size, the resultant woven material may become easily clogged, resulting in reduced release from the pouch of substances derived from the smokeless material, and this may be undesirable for the user.

Conversely, it may be undesirable for the fibers to be too thick. For example, if the thickness of the fibers is greater than 100 dtex, the resultant woven material may exhibit an increased stiffness and a reduced flexibility, which may result in a pouch that is uncomfortable for the user and causes irritation.

In some embodiments, in the woven material, the cover factor K is preferably between 1600 and 6400, and is more preferably between 3200 and 4000. The cover factor K is determined in accordance with the following equation:

K=(N×(A)<_{1/2}>/T)+(M×(B)<_{1/2}>/S)

in which, in respect of woven fabric,

represents the cover factor of the woven fabric,

represents the warp density (yarns/10 cm),

M represents the weft density (yarns/10 cm),

A represents the thickness (dtex) of the warp yarns,

B represents the thickness (dtex) of the weft yarns,

T represents the specific gravity of the warp yarns, and

S represents the specific gravity of the weft yarns.

The cover factor K of the woven material correlates with the pore size of the material, wherein the lower the cover value, the greater the pore size. If the cover value for the material is less than 1600, the pore size of the material may be too great. If the cover factor K is greater than 6400, the pore size may be too small and may be prone to clogging.

In some embodiments, the thickness of the woven material comprising the pouch is greater than 15 μm, and may be greater than 20, 35, 50, 80, 100, 120, 150, 175, 18 or 200 μm. The pouch material may, in some embodiments, have a thickness of less than 500, 450, 400, 350, 300, 250, 200, 150, or 100 μm. In some embodiments, the woven material may have a thickness in the range of between 50 and 150 μm, in some implementations preferably between 70 and 100 μm.

Conventional pouches for smokeless oral tobacco products comprise fiber web material. Due to the orientation of the fibers in such materials, fiber webs have a much greater mechanical strength when stressed in a longitudinal direction versus a lateral (perpendicular) direction. In contrast, the woven materials described above may have equal mechanical strength in all directions. In some embodiments, the woven materials may have the further advantage of having a surface texture that is pleasant to the touch and may offer the reduced likelihood of irritation in the mouth of the user.

### Non-Woven Materials

In some embodiments, the material comprising the pouch is not a purely woven material, but is a composite material, comprising woven and non-woven material. Such material resembles a combination of woven material and fiber web material. In some embodiments the composite material comprises fibers of PO material.

Composite materials comprising woven and non-woven materials may be advantageous as they may be able to be bonded, joined, and/or sealed using methods which are not suitable for use with materials that are exclusively woven or non-woven. For example, composite materials may be sealable by means of ultrasonic or heat treatment, whereas woven PLA material may not be suitable for heat sealing.

In further embodiments, in addition to woven and/or composite materials, the material may also be present in the pouch in the form of a fiber web. In some embodiments the fiber web material may comprise PLA and/or PO material.

The fibers produced as described above may be converted into non-woven fiber webs by known techniques. Alternatively, melt blowing or electro-spinning techniques may also be used and in these methods, a fiber web is produced at the same time the fiber is formed.

### Appearance

In some embodiments, woven PLA and PO materials may be generally transparent, and as they have no color, these materials may be resistant to staining. This offers an advantage when used in combination with smokeless material because such material can have a high moisture content. Consequently, materials used in the production of conventional pouches often become stained and discolored by the action of the moist contents. Such tarnishing of the pouch can be unsightly and unappetizing for the user.

In some embodiments, the pouch may be colored. Color may be imparted to the material by any suitable method. For example, coloring may be added during the manufacture of the fibers comprising the pouch material.

The color may result in the material having a transparent coloring. Alternatively, the material may have an opaque, entirely colored, appearance.

One or more colors may be used. The coloring may be associated with the particular smokeless tobacco product. For example, if the smokeless oral product contains a mentholated smokeless tobacco material then it may have a green color.

### Environmental Considerations

PLA is a sustainable alternative to viscose or petrochemical-derived products, since the lactides from which it is ultimately produced can be derived from the fermentation of agricultural by-products such as corn starch or other carbohydrate-rich substances such as maize, sugar, or wheat.

### Additional Materials

The pouch may include or comprise additional materials in combination with the PLA and/or PO material.

Additional material present in the pouch may include or comprise woven or non-woven materials, or may include or comprise a combination of woven and non-woven materials.

The additional material preferably comprises degradable material. For example, polymer groups including polyanhydrides, polyesters (such as those made from diacids and diols), polycarbonates, polyorthoesters, polyphosphazenes, polyesterurethane, polycarbonateurethane, and polyaminoacids, are degradable because they have hydrolysable bonds in the backbone of the polymer chain.

The additional material may comprise a natural polymer such as a polysaccharide, proteins, and polyhydroxybutyrate including its various copolymers.

Another degradable polymer, which may be used as a component of the pouch material, is polyvinylalcohol or its various copolymers.

### Additives

Additives can be applied to the material of the pouch. Such additives could be, for example, where local regulations permit, plasticizers, preservatives, anti-bacterial agents, flavorants, or pharmacological substances.

Additives may be applied in the form of microcapsules, for example, microcapsules comprising liquid flavorants. Alternatively or additionally, additives may be applied in the form of powders, such as powder blended or added to the smokeless material. Additives may also be applied by spray drying. For example, spray-dried flavorant may be applied to the smokeless material prior to incorporation within the pouch.

Smokeless Material

The ‘smokeless material’ used herein includes, but is not limited to, smokeless tobacco material such as Swedish-style snus, and also tobacco substitute materials such as tobacco and nicotine free alternatives to snus.

Nicotine-free alternatives to snus may comprise vegetable fiber portions, flavored with aromas to imitate the taste of tobacco.

‘Tobacco’ as used herein includes any part, such as the leaves, flowers, or stems, of any member of the genus Nicotiana and reconstituted materials thereof. It includes derivatives such as specific compounds found in natural tobacco, such as nicotine, whether extracted or synthesized, as well as structural derivatives such as the fibrous portion of a tobacco leaf. It further includes tobacco substitutes which comprise individual chemicals and/or complex chemical entities which, when appropriately prepared, physically resemble natural tobacco.

Tobaccos used in the present invention may include types of tobaccos such as dark air cured tobacco, flue-cured tobacco, burley tobacco, Oriental tobacco, Maryland tobacco, dark tobacco, dark-fired tobacco and Rustica tobaccos, as well as other rare or specialty tobaccos. In preferred embodiments, dark air-cured tobacco is used.

In one embodiment, relatively dry tobacco is ground, sieved and sorted into stem fractions and lamina fractions, each of these being further sorted into small (between about 0.01 to 0.4 mm), medium (between about 0.4 to 0.7 mm) and large (between about 0.7 to 1.0 mm) particles. The desired ratios of particle sizes and tobacco fractions are obtained. The relative amounts of stem to lamina will have some effect on flavor and nicotine delivery, as these components reside most significantly in the lamina portion. Flavor and other characteristics are also influenced by the particular tobacco type used and the curing method it has undergone. For tobacco types which are provided with no distinction between stem and lamina, Rustica or Oriental for example, there may be only a separation of tobacco particles by size.

The relative ratios of particle sizes may affect the final product, making it relatively drier or moister/stickier. The tobacco used may comprise an approximately equal proportion of stem to lamina fractions, or may comprise a larger proportion of lamina than stem. Typical snus products generally contain a full spectrum of particle sizes to effectively release nicotine in a reasonable amount of time, while maintaining structural integrity.

The blend of tobacco particles is mixed with water and, typically, salt. Residual moisture from the tobacco and the added water combine to raise the moisture levels of the mixture to between 25 and 60%. Salt is one form of flavorant; optionally it may be excluded and/or another flavorant may be added at this stage.

The amount of tobacco within the tobacco formulation may vary. The amount of tobacco within the tobacco formulation may be from at least about 25% to at least about 40%, on a dry weight basis.

### Additives to the Smokeless Material

The smokeless material may further include other components. These components may, for example, be included in order to alter the organoleptic properties of the formulation, contributing to the sensory perception by the consumer. The particular components and the amounts in which they are included in the smokeless material of the present invention will vary depending upon the desired flavor, texture, and other characteristics.

For example, the following components may be included:

(a) flavoring agents;

(b) humectants;

(c) pH adjusters or buffering agents;

(d) disintegration aids;

(f) colorants.

As used herein, the terms “flavor” and “flavorant” refer to materials which, where local regulations permit, may be used to create a desired taste or aroma in a product. They may include extracts and/or may be imitation, synthetic or natural ingredients or blends thereof. They may be in any suitable form, for example, oil, liquid, or powder.

The smokeless material may comprise sensates in addition to flavorants, and these may include cooling agents and heating agents.

The smokeless material may also comprise at least one humectant, such as glycerol, propylene glycol, and/or the like.

The smokeless material may also comprise at least one pH adjuster or buffering agent, which may include metal hydroxides, such as sodium hydroxide and potassium hydroxide, and other alkali metal buffers such as potassium carbonate, sodium carbonate and sodium bicarbonate.

The smokeless material may also comprise at least one preservative, such as potassium sorbate.

In order to address various issues and advance the art, the entirety of this application for SMOKELESS ORAL PRODUCTS (including the Cover Page, Title, Headings, Field, Background, Brief Description of the Drawings, Detailed Description, Claims, Abstract, Figures, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition.

As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, structural, and/or other aspects of the disclosure are not to be considered limitations on the disclosure as defined by the claims or limitations on equivalents to the claims. It is to be understood that the embodiments described herein may be readily configured and/or customized for a wide variety of other applications and/or implementations.

What is claimed is:

1. A smokeless oral product, comprising:
a permeable pouch comprising a woven material, and
smokeless material contained in the pouch.

2. The smokeless oral product according to claim 1, wherein the permeable pouch comprises a composite material comprising both woven and non-woven material.

3. The smokeless oral product according to claim 1, wherein the permeable pouch comprises polylactide material.

4. The smokeless oral product according to claim 1, wherein the permeable pouch comprises polyolefin material.

5. The smokeless oral product according to claim 1, wherein the smokeless material comprises smokeless tobacco material.

6. The smokeless oral product according to claim 1, wherein the smokeless material is Swedish-style snus.

7. The smokeless oral product according to claim 1, wherein the smokeless material comprises tobacco substitute material which is tobacco and nicotine free.

8. A method of producing a smokeless oral product, comprising providing a permeable pouch comprising a woven polymer material, wherein the permeable pouch comprises smokeless material contained in the pouch.

9. The method as claimed in claim 8, comprising sealing the woven polymer material using heat-melt welding technique.

10. The method as claimed in claim 8, comprising sealing the woven polymer material using an ultrasonic welding technique.
